(19) United States
(12) Patent Application Publication
(10) Pub. No.: US 2025/0282101 A1
(43) Pub. Date: Sep. 11, 2025

(54) 3D PRINTING USING ENERGY SOURCES

(71) Applicant: Peridot Print LLC, Palo Alto, CA (US)

(72) Inventors: Ferran ESQUIUS BERENGUERAS, Sant Cugat del Valles - Barcelona (ES); Esteve Comas Cespedes, Sant Cugat del Valles - Barcelona (ES); Jordi Bautista Ballester, Sant Cugat del Valles - Barcelona (ES); David Ramirez Muela, Sant Cugat del Valles - Barcelona (ES); Xavier Soler Pedemonte, Sant Cugat del Valles - Barcelona (ES)

(73) Assignee: Peridot Print LLC, Palo Alto, CA (US)

(21) Appl. No.: 19/215,891

(22) Filed: May 22, 2025

Related U.S. Application Data
(62) Division of application No. 18/018,816, filed on Jan. 30, 2023.

(51) Int. Cl. B29C 64/393; B29C 64/165; B29C 64/291; B29K 75/00; B33Y 10/00; B33Y 30/00; B33Y 50/02

(52) U.S. Cl. CPC B29C 64/393; B29C 64/165; B29C 64/291; B33Y 10/00; B33Y 30/00; B33Y 50/02; B29K 2075/00

(57) ABSTRACT

A three-dimensional (3D) printer and a method 3D printing are disclosed herein. The method of 3D printing includes receiving a print job data for a 3D object to be generated from a build material with a right limit temperature of the build material crystallization curve higher than a left limit temperature of the build material fusing curve of the build material. The method further includes generating a layer of the build material and selectively depositing an energy absorbent fusing agent to the layer of the build material based on the print job. Finally, the method includes emitting energy at a set of wavelengths in the range of 430 to 1200 nm to the layer of the build material to cause the build material on which the energy absorbent fusing agent was deposited to melt, coalesce, and then solidify upon cooling.

### CROSS-REFERENCE TO RELATED APPLICATIONS

This application entitled “3D Printing Using Energy Sources,” is a divisional application of U.S. application Ser. No. 18/018,816 entitled “3D Printing Using Energy Sources,” and filed Jan. 30, 2023, which is a national stage entry application of PCT Application No. US2020/044304 entitled “3D Printing Using Energy Sources,” and filed Jul. 30, 2020. The entirety of the aforementioned applications are incorporated by reference herein.

### BACKGROUND

Some additive manufacturing or three-dimensional printing systems generate 3D objects by selectively solidifying portions of a successively formed layers of build material in a layer-by-layer basis.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic standard Differential Scanning calorimetry curve showing an example of a material to be used by a 3D printer to generate a 3D object;

FIG. 2 is a schematic diagram of an example graph indicative of the emission wavelengths of a focused energy source and the absorption rate of fusing agent and build material;

FIG. 3 is a schematic diagram showing an example of a 3D printer to generate a 3D object;

FIG. 4 is a flowchart of an example method of generating a 3D object by a 3D printer; and

FIG. 5 is another schematic diagram showing an example of a 3D printer to generate a 3D object.

### DETAILED DESCRIPTION

The following description is directed to various examples of additive manufacturing, or three-dimensional printing, apparatus and processes to generate 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printers generate 3D objects based on data in a 3D model of an object to be generated, for example, generated using a CAD computer program product. 3D printers may generate 3D objects by selectively processing layers of build material. For example, a 3D printer may selectively solidify portions of a layer of build material, e.g. a powder, corresponding to a slice of a 3D object model of the object to be generated, thereby leaving the portions of the layer un-solidified in the areas where no 3D object is to be generated. The combination of the generated 3D objects and the un-solidified build material may also be referred to as build bed. The volume in which the build bed is generated may be referred to as a build chamber.

Some 3D printers selectively solidify portions of a build material layer corresponding to the geometry of the object to be generated through the ejection of a printing fluid on the build material layer. To perform the selective solidification, some 3D printers heat a build material layer with radiant heat from, e.g. halogen lamps or tungsten lamps. This may be referred to pre-heating and is to heat of the build material layer to a temperature slightly below the melting point of the build material. Then, the printing fluid is ejected, which in some examples, may be an energy absorbing printing fluid, such as a fusing agent. The fusing agent is to absorb further radiant heat to cause the portions of build material on which it has been deposited to further heat up about the melting temperature and thereby to melt, coalesce, sinter, or fuse the build material which then may solidify upon cooling. In some examples, the composition of the fusing agent comprises carbon black particles dispersed in a liquid carrier, such as water.

Suitable powder-based build materials for use in additive manufacturing include, where appropriate, at least one of polymers, metal powder or ceramic powder. In some examples, non-powdered build materials may be used such as gels, pastes, and slurries.

The internal molecular structure of a polymeric build material may comprise a first part which is crystalline and a second part that is amorphous or non-crystalline. In the crystalline part, the atoms that form the polymeric material are arranged to repeat periodically in space, and are packed in an organized manner. In the amorphous part, however, the atoms that form the material lack an order, and are arranged in a random manner. Therefore, the internal molecular structure of a polymeric build material may define a degree of crystallization specific for that type of polymeric build material. The degree of crystallization may be defined as the percentage of the crystalline part with respect to the overall internal structure of the polymer (i.e., crystalline and amorphous).

Different types of polymeric build materials may have different degrees of crystallization and may thereby behave in different ways when used in an additive manufacturing process.

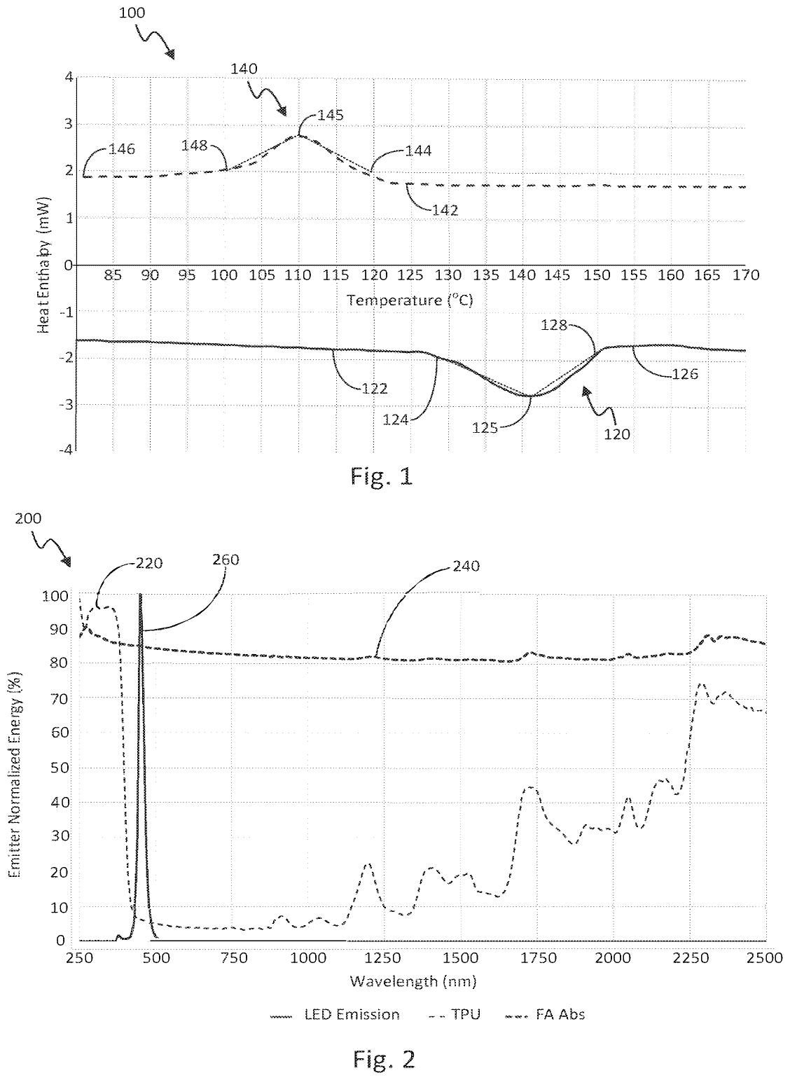

Referring now to the drawings, FIG. 1 is a schematic standard Differential Scanning Calorimetry curve 100 showing an example of a Thermoplastic Polyurethane (TPU) material to be used by a 3D printer to generate a 3D object.

As mentioned above, during the additive manufacturing process layers of build material are preheated, thereby raising the temperature of the build material close to but below the melting point of the build material. In some examples, the melting point may also be referred to as fusing point. A fusing agent is selectively deposited to absorb additional energy from a fusing energy source thereby raising the temperature of the portions of build material in which the fusing agent is deposited. This selectively raises the temperature of the portions with fusing agent above the melting point and leaves the temperature of other portions of build material below the melting point. In an example, after the generation of the print job in the 3D printer, the build volume is cooled down. In another example, the already generated build material layers may begin to cool down whilst newly formed layers are being processed. As the build volume cools down, the build material corresponding to the fused portions starts to crystallize (e.g., harden). After the cooling, the solidified parts, corresponding to the 3D objects to be generated, may be separated from the unfused build material. The unfused build material may be recycled for subsequent print jobs.

Unlike metals, whose melting point represents the equilibrium temperature between solid and liquid, polymeric build materials fuse and crystallize at a range of temperatures which is governed by the internal structure of the polymer. For example, when Polyamide PA12 build material particles are heated, the particles start to melt at about 161° C. At 186 C about 50% of the material is melted, and at 194 C about the 100% of the material is melted. When the melted polyamide build material particles are then cooled, they start to crystallize at 155° C., at 147 C about 50% of the material is crystallized, and at 122 C and around 100% of the fused material is crystallized.

In the polyamide PA12 example, build material that is intended not to be fused may not reach the melting temperature of 161° C. because these particles would fuse together and then crystallize upon cooling. If build material particles that are not intended to be fused and crystallized do actually at least in part fuse, the particles tend to agglomerate thereby causing difficulties in separating the 3D objects from the agglomerated particles that were not intended to be fused. In some examples, these particles bind to the 3D object thereby cause the object to not meet part quality requirements. Furthermore, crystallized portions tend to deform by, for example, bending upwards which may lead to a collision risk with the moveable parts above the build material layer in a 3D printer; such as a carriage, a recoater, and the like.

As mentioned above, different types of polymeric build materials may have different degrees of crystallization and may thereby behave in different ways upon being used in an additive manufacturing process. This is the case of materials with low degrees of crystallization, such as amorphous thermoplastics and elastomeric materials.

Graph 100 shows the standard Differential Scanning Calorimetry (DSC) curve of a material with a low degree of crystallization, namely a Thermoplastic Polyurethane (TPU). The DSC curve generation processes are defined in different standards which may define different characteristics and conditions of the curve, these standards may be for example ISO 11357-1, ASTM D 3417/3418, DIN 53 765, and other international and/or national standards. In the present disclosure and for consistency purposes, the terminology used is compliant with terms defined in ISO 11357-1, however it is to be understood that any analogous terminology from a different standard may be used without departing from the scope of the present disclosure.

The DSC curve 100 represents the behavior of a build material whilst being heated and cooled; and comprises a fusing curve 120 and a crystallization curve 140.

Once the build material is heated, the polymeric particles start to fuse at left limit 122, also referred to as the melting onset, of the fusing curve 120. In the present disclosure, fusing may be understood as a change from a solid crystalline state into an amorphous liquid state. No loss of mass or chemical change may occur in the fusing process. The fusing process of the polymeric particles is accompanied by an endothermic enthalpy change (i.e., integral of the fusing DSC curve 120). As shown in FIG. 1, the left limit 122 is reached when the build material is heated to about 114° C. 50% of the build material particles may be fused in the melting peak temperature 125 at about 141° C. Almost all build material particles may be fused when the temperature of the particles reaches the right limit 126 or melting end temperature at about 155° C. ISO 11357-1 further defines a melting extrapolated onset temperature 124 and a melting extrapolated end temperature 128. The melting extrapolated onset temperature 124 (i.e., at 128° C. in DSC curve 100) is the intersection of the extrapolated linear section of the falling peak 125 edge with the baseline extrapolated from temperatures below the peak 125, and may indicate the temperature in which a low percentage of build material particles (e.g., 1%, 2%, 3% or 5%) are fused. Similarly, the melting extrapolated end temperature 128 (i.e., at 150° C. in DSC curve 100) is the intersection of the linear section of the rising peak 125 edge with the baseline extrapolated from temperatures above the peak 125, and may indicate the temperature in which a low percentage of build material particles are still not fused (e.g., 95%, 97%, 98% or 99% of build material particles are fused).

As shown in the upper trace of FIG. 1, as the fused build material particles are cooled, some of the polymeric particles start to crystallize at the right limit 142 of the crystallization curve 140. In the example material, the right limit 142 and therefore the start of crystallization of the fused build material particles, is reached once the temperature of the build material particles is about 124° C. 50% of the fused build material particles may be crystallized in the crystallization peak temperature 145 at about 110° C. Almost all fused build material particles may be crystallized when the temperature of the particles reaches the left limit 146 at about 82° C. In addition, ISO 11357-1 further defines a crystallization extrapolated onset temperature 144 and a crystallization extrapolated end temperature 148. The crystallization extrapolated onset temperature 144 (i.e., at 120° C. in DSC curve 100) is the intersection of the extrapolated linear section of the falling peak 145 edge with the baseline extrapolated from temperatures above the peak 145, and may indicate the temperature in which a low percentage of build material particles (e.g., 1%, 2%, 3% or 5%) are crystallized. Similarly, the crystallization extrapolated end temperature 148 (i.e., at 101° C. in DSC curve 100) is the intersection of the linear section of the rising peak 145 edge with the baseline extrapolated from temperatures below the peak 145, and may indicate the temperature in which a low percentage of build material particles are still not crystallized (e.g., 95%, 97%, 98% or 99% of build material particles are crystallized).

As it can be noted, and unlike the above example with reference to the Polyamide (PA12), the temperature corresponding to the left limit 122 of the fusing curve 120 is below the right limit 142 of the crystallization curve 140 (the fusing curve 120 and the crystallization curve 140 overlap). In other words, once the polymeric build material particles start to fuse, the particles are already crystallizing. Furthermore, the build material particles on which no fusing agent was applied which are preheated below the melting temperature risk crystallizing as well. Additionally, in order to achieve good mechanical properties in the generated 3D objects, the build material corresponding to the 3D objects needs to be properly fused.

It is to be noted that the above temperatures are example temperatures tested in the laboratory under the specific conditions disclosed in the standards (i.e., ISO 11357-1) and by all means are not indicative of the temperature behavior patterns of the build material in a 3D printer. However, the shapes of the melting and crystallization curves and teachings thereafter may be applied to the use of the build material in an additive manufacturing process. For example, the left limit 122 temperature of the build material fusing curve 120 of the exemplified build material may be about 105° C. under additive manufacturing conditions, rather than 114° C. under the standard conditions.

Build materials that behave like the example build material of FIG. 1 may be build materials that have a degree of crystallization below 25%. In other examples, the materials with a degree of crystallization of 20%, 15%, 10%, 5% or 2% may behave in a similar way, for example, TPU, TPA, or elastomeric materials. Other polymeric build materials, such as, polyamides or polypropylene, may have higher degrees of crystallization of about 50%.

The degree of crystallization depends on the material and may be measured, for example, by quantifying the crystallization energy of a given material. The crystallization energy may be measured as the integral of the crystallization curve 140 of the DSC curve 100. For example, a polyamide (e.g., PA12) may have a crystallization energy of about 54.21 J/g and TPU may have a crystallization energy of about 19.24 J/g; therefore the degree of crystallization of a polyamide material is about three times higher (i.e., is three times ‘more crystalline’) that of TPU. The degree of crystallization as a percentage of a first material may be obtained by comparing a known percentage of crystallization of a second material and its corresponding second material crystallization energy, with the crystallization energy of the first material.

The energy to be supplied to fuse the build material particles per gram of build material (i.e., the enthalpy change) is illustrated as the integral of the DSC fusing curve 120. The build materials that behave like the example build material of FIG. 1 may have an integral for the standard DSC fusing curve below 35 J/g, for example, 30 J/g, 25 J/g, 20 J/g, 10 J/g, or 5 J/g. The integral of the fusing curve 120 of the exemplified build material from FIG. 1 is about 23 J/g. It is to be noted that the fusing curve integrals of the exemplified build materials are smaller than crystalline materials which have narrower but spikier curves leading to a greater area below the fusing curve. For example, polyamide (PA 12) which has a fusing curve integral value of 104 J/g.

FIG. 2 is a schematic diagram of an example graph 200 indicative of the emission wavelengths of a focused energy source and the absorption rate of fusing agent and build material. The build material may be the build material exemplified with reference to FIG. 1. The focused energy source that emits energy at the emission wavelengths may be the energy source from a 3D printer.

The graph 200 shows the absorption of energy of a white build material, such as build material 220 of FIG. 1 and a carbon-black fusing agent 240 based on the emitted energy wavelengths. The white build material 220 absorbs substantially all the emitted energy at wavelengths below 450 nm, reflects substantially all the emitted energy at wavelengths between 450 nm and 1200 nm (absorption rate of about 5%), and absorbs a higher quantity of energy at wavelengths above 1200 nm. However, the carbon-black fusing agent 240 absorbs substantially all (>80%) the emitted energy across the spectrum. Therefore, at wavelengths below 450 nm, both the build material 220 and the fusing agent 240 absorbs substantially all the emitted energy; and at wavelengths between 450 nm and 1200 nm the build material 220 fairly absorbs energy and the fusing agent 240 keeps absorbing substantially all the emitted energy.

By emitting energy at wavelengths between 450 nm and 1200 nm, the energy source may provide a higher spectral selectivity ratio between portions of a build material layer in which the fusing agent has been deposited and the portions of the build material layer on which no fusing agent is applied. The spectral selectivity ratio may be understood as the ratio of the energy absorbed by the print bed (i.e., build material without fusing agent) in relation with the absorbed energy by the printed part (i.e., build material with fusing agent). For example, a spectral selectivity ratio of 2 indicates that the build material with fusing agent absorbs twice as much energy than the build material without fusing agent. In an example, the spectral selectivity ratio may be determined by measuring, after the application of energy, the temperature of the build material with fusing agent and the temperature of the build material without fusing agent and calculating the ratio therefrom.

In an example, emitting energy at wavelengths between 450 nm and 1200 nm to a white build material may have a spectral selectivity ratio between portions of a build material layer in which the fusing agent has been deposited and the portions of the build material layer with no fusing agent of more than 1:7, 1:10, 1:15, or 1:20. Emitting energy at the wavelength corresponding to 455 nm to the build material exemplified in FIG. 1 may have a spectral selectivity ratio between portions of a build material layer in which the fusing agent has been deposited and the portions of the build material layer with no fusing agent of more than 1:12. A halogen lamp emitting energy across the electromagnetic spectrum (e.g., near UV, visible, near infrared) and having an emission peak of emissions at about 1000 nm to a layer of the build material of FIG. 1, may have a spectral selectivity ratio between portions of a build material layer in which the fusing agent has been deposited and the portions of the build material layer with no fusing agent of less than 1:5.

Therefore, emitting energy at wavelengths between 450 nm and 1200 nm to a layer of the build material with a right limit 142 temperature of the build material crystallization curve 140 higher than the left limit 122 temperature of the build material fusing curve 120 (e.g., build material of FIG. 1), may properly fuse the portions of the layer of build material with the fusing agent while leaving the portions of the layer of build material without the fusing agent at a substantially lower temperature than the temperature corresponding to the left limit 122 temperature of the build material fusing curve 120. Consequently, this enables the manufacture of 3D objects having good mechanical properties without being surrounded by an agglomerated non-fused build material. As mentioned above, the generation of agglomerated non-fused build material difficult decaking and cleaning operations.

The 3D printer may have a plurality of alternative energy sources that emit energy at wavelengths between 450 nm and 1200 nm. The energy source may, for example, emit energy at a broad band of wavelengths, a narrow band of wavelengths, or a single wavelength comprised between the range of wavelengths between 450 nm and 1200 nm. A broad band of wavelengths may be understood as a band of wavelengths wider than 120 nm, and a short band of wavelengths may be understood as a band of wavelengths equal or narrower than 120 nm.

In the illustrated example, the energy source is to emit energy at short band of wavelengths ranging from 445 nm to 455 nm (e.g., blue light), for example using a suitable blue LED, which may be completely absorbed by the fusing agent 240 and may be substantially reflected by the white build material 220. Other alternative bands of wavelengths may include at least part of the cyan band (500-520 nm), green band (520-565 nm), yellow band (565-590 nm), orange band (590-625 nm), red band (625-740 nm), or a combination thereof.

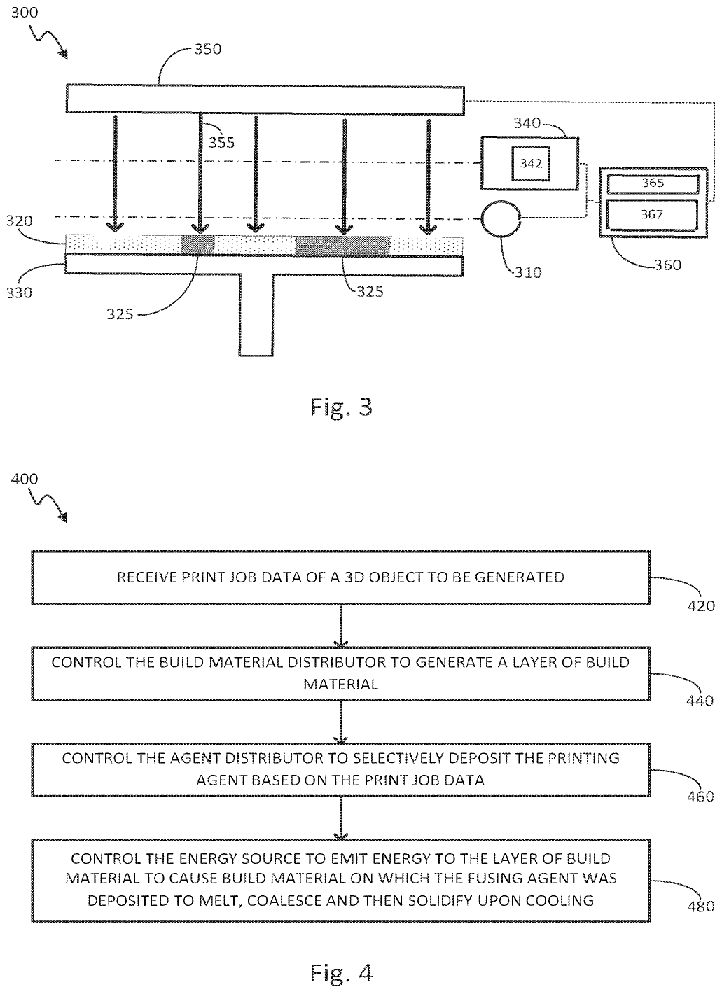

FIG. 3 is a schematic diagram showing an example of a 3D printer 300 to generate a 3D object.

The 3D printer 300 elements are to interact with a platform 330 in which the build volume is generated thereon. In some examples, the platform 330 is an integral part of the 3D printer 300. In other examples, the platform 330 is part of a removable build unit (not shown) that is to engage and disengage from the 3D printer 300. The platform 330 is a moveable platform within a build chamber from the 3D printer 300. In some examples, the platform 330 is movable vertically within the build chamber, e.g., downwardly for a distance corresponding to the thickness of the successive build material layer to be generated. Some examples of build material layer thicknesses are 80 microns, 60 microns, 50 microns, 30 microns and 20 microns.

The 3D printer 300 may further comprise a build material distributor 310 to generate a layer of build material 320 on the build platform 330 or on the uppermost generated build material layer. The build material distributor 310 may comprise a recoating roller, a doctor blade, or an overhead build material dispensing hopper, for instance. The build material 320 is a build material that has a suitable right limit temperature on the build material crystallization curve higher than the left limit temperature of the build material fusing curve, for example, the build material with reference to FIG. 1 (e.g., TPU, TPA, Elastomer). In an example, the build material 320 is a build material in which the crystallization extrapolated onset temperature of the build material crystallization curve is higher than the melting extrapolated onset temperature of the build material fusing curve.

In an example, the 3D printer 300 may comprise an internal reservoir including the build material with an internal build material conveying system to supply the build material from the internal reservoir to the build material distributor 340. Additionally, the internal reservoir may be coupleable to an input build material conveying system so that build material from an external source (e.g., build material bulk tank) may be conveyed to the reservoir. In another example, the 3D printer 300 may comprise a build material supply enclosure to receive a build material supply including the build material, and the internal build material conveying system to supply the build material from the internal reservoir to the build material distributor 340.

The 3D printer 300 further comprises the agent distributor 340. The agent distributor 340 may be implemented as a carriage to scan over the width and/or the length of the platform 330. In an example, the agent distributor 340 spans the full width of the platform 330 and may scan along the length of the platform 330. In another example, the agent distributor 340 spans the full length of the platform 330 and may scan along the full width of the platform 330. In yet another example, the agent distributor 340 does not span either the full width or the full length of the platform 330 but may scan over the width and the length of the platform 330.

In some examples, the 3D printer 300 comprises a container storing the energy absorbing fusing agent 342 which is fluidically connected to the agent distributor 340. In other examples, however, the 3D printer 300 comprises an enclosure to receive an external supply or cartridge of the energy absorbing fusing agent 342 which, when in use, is fluidically connected to the agent distributor 340.

The agent distributor 340 is to selectively deposit an energy absorbent fusing agent 342 on the build material 320 layer (e.g., portions 325) by means of, for example, a printhead or a plurality of printheads. The printhead may be a thermal inkjet printhead or a piezoelectrical printhead, for instance. In an example, the energy absorbent fusing agent 342 comprises carbon-black particles in a liquid vehicle. The fusing agent 342 is to absorb heat and cause the build material in which it is applied (e.g., portions 325) to fuse or melt. The fusing agent 342 may behave in a similar way as the fusing agent described with reference to FIG. 2. In an example, the fusing agent is to absorb over 75% of the energy received from an energy source 350. In other examples, the fusing agent is to absorb over 80%, 85%, 90%, 95% or 97% of the energy received from the energy source 350.

The 3D printer 300 includes an energy source 350 to emit energy 355 to the build material 320 layer. In the example, the energy source 350 is implemented as a static overhead top lamp array located above the build material 320 layer. The static energy source may be designed as an array of energy sources such that at least one energy source from the energy source array is to emit energy 355 to each portion of the build material 320 layer.

The energy source 350 may comprise an array of solid-state emitters. In an example, the array of solid-state emitters is an array of Light-Emitting Diodes (LED). In another example, the array of solid-state emitters may be an array of Laser Diodes (LD) such as Edge Laser Diodes (ELD). In another example, the array of solid-state emitters may be an array of Vertical-Cavity Surface-Emitting Lasers (VCSEL). In yet another example, the array of solid-state emitters may be a combination of at least two of LEDs, LDs and VCSELS.

LEDs, LDs and VCSELs are formed by semiconductor diodes. The choice of the semiconductor material determines the wavelength of the emitted light beam, which may range from the infra-red to the UV spectrum. In the examples herein, the type of solid-state emitters of the solid-state emitters array is selected to emit energy 355 in a narrow-band of wavelengths to be absorbed by a fusing agent.

In the present disclosure, a narrow-band of wavelengths may be understood as a band of wavelengths from the electromagnetic spectrum which is no wider than 120 nm. In some examples, the narrow-band of wavelengths may include monochromatic light, which comprises a single wavelength. Other examples of narrow-band of wavelengths include a short band of wavelength ranges such as 5 nm, 10 nm, 15 nm, 20 nm, 25 nm, 50 nm, 75 nm, 90 nm, 100 nm or 120 nm. The band of wavelengths width of commercially available blue LEDs and UV LEDs range from 50 to 70 nm. The band of wavelengths width of commercially available ELDs are in the order of 120 nm.

The energy source 350 is to emit energy 355 at a set of wavelengths comprised in the range of 430 to 1200 nm to increase the spectral selectivity ratio between the portions 325 of a build material 320 layer in which the fusing agent 342 have been deposited and the portions of the build material 320 layer in which without fusing agent, to cause the build material in the portions 325 to melt, coalesce and solidify upon cooling. Examples of the emission wavelengths of the energy source 350 may be found with reference to FIG. 2.

The 3D printer 300 further comprises a controller 360. The controller 360 comprises a processor 365 and a memory 367 with specific control instructions to be executed by the processor 365. The controller 360 is coupled to the build material distributor 310, the agent distributor 340 and the energy source 350. The controller 360 may control the operations of the elements that it is coupled with. The functionality of the controller 360 is described further below with reference to FIG. 4.

In the examples herein, the controller 360 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 360 may be, at least partially, implemented in the form of an electronic circuitry. The controller 360 may be a distributed controller, a plurality of controllers, and the like.

FIG. 4 is a flowchart of an example method 400 of generating a 3D object by a 3D printer, for example the 3D printer 300 of FIG. 3. The method 400 may involve previously disclosed elements from FIG. 3 referred to with the same reference numerals. In some examples, method 400 may be executed by the controller 360.

At block 420, the controller 360 receives print job data (e.g., CAD computer program product) of a 3D object to be generated. The print job data comprises the areas from the build material layers to be generated to be solidified. In some examples, the controller 360 may slice the print job data. In other examples, the controller 360 may receive a single slice or a plurality of slices comprising the areas from the build material 320 layer to be solidified.

At block 440, the controller 360 controls the build material distributor 310 to generate a layer of build material 320. The build material is a similar build material as the build material exemplified in FIG. 1.

At block 460, the controller 360 controls the agent distributor 340 to selectively deposit the fusing agent 342 on the build material layer based on the print job data. In an example, the fusing agent is the fusing agent exemplified in FIG. 2.

At block 480, the controller 360 controls the energy source 350 to emit energy 355 to the layer of build material 320 to cause build material on which the fusing agent was deposited (e.g., portions 325) to melt, coalesce and the solidify upon cooling. The energy source 350 emits the energy 355 at a set of wavelengths comprised in the range of 430 to 1200 nm to increase the spectral selectivity ratio between the portions 325 of the build material 320 layer in which the fusing agent has been deposited and the portions of the build material 320 layer with no fusing agent.

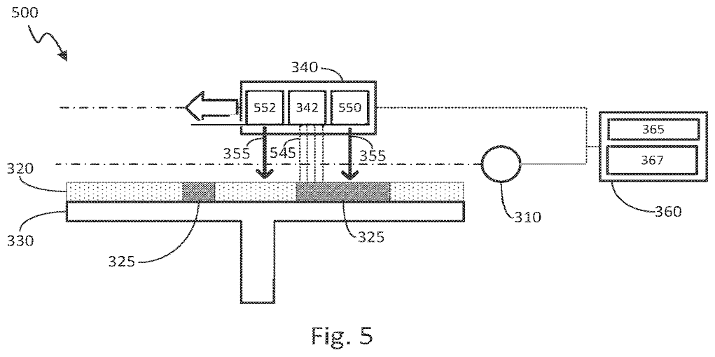

FIG. 5 is another schematic diagram showing an example of a 3D printer 500 to generate a 3D object. The 3D printer 500 may involve previously disclosed elements from FIG. 3 referred to with the same reference numerals. The 3D printer 500 comprises the platform 330 where the build material layer is to be generated thereon; the build material distributor 310 to generate the build material layer; and the controller 360 to control the build material distributor 310. The build material used by the 3D printer 500 may be the same build material as the build material exemplified in FIG. 1.

The energy source 550 of the 3D printer 500 is in a scanning carriage located above the build material 320 layer to scan above and throughout the width and/or the length of the area in which the build material layer is to be generated. The scanning carriage may be the same carriage or a different carriage than the agent delivery distributor 340 described above.

In an example, the energy source 550 is to span the full width of the area in which the build material 320 layer is to be generated and is to scan along the length of the area in which the build material 320 layer is to be generated. In another example, the energy source 550 is to span the full length of the build material 320 layer and may scan along the full width of the build material 320 layer. In yet another example, the energy source 550 may not span either the full width or the full length of the area in which the build material 320 layer is to be generated; and is thereby may scan over the width and the length of the area in which the build material 320 layer is to be generated.

Additionally, the energy source 550 scanning carriage may comprise a plurality of rows of energy sources, each row spanning substantially the width of the platform 330. In an example the scanning carriage may have two rows of energy sources spanning substantially the width of the platform 330 separated by a row the agent distributor to selectively eject fusing agent 342 therefrom. This arrangement enables the 3D printer 350 to fuse portions of a layer of build material in the two scanning directions. Furthermore, enables to apply more energy to the portions 325 of build material with fusing agent to fuse in a more efficient way thereby generating 3D objects with better mechanical properties.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printer comprising:
a build material distributor to generate layers of a build material having a right limit temperature of the build material crystallization curve higher than a left limit temperature of the build material fusing curve;
an agent distributor to selectively deposit an energy absorbent fusing agent to a layer of build material;
an energy source to emit energy at a set of wavelengths comprised in the range of 430 to 1200 nm, and
a controller to:
   receive print job data of a 3D object to be generated;
   control the build material distributor to generate a layer of build material;
   control the agent distributor to selectively deposit the fusing agent based on the print job data;
   control the energy source to emit energy to the layer of build material to cause build material on which the fusing agent was deposited to melt, coalesce and then solidify upon cooling.

Feature set 2: A 3D printer with feature set 1, further comprising a reservoir including the build material.

Feature set 3: A 3D printer with any preceding feature set 1 to 2, wherein the energy source is to provide spectral selectivity ratio between portions of a build material layer in which the fusing agent has been deposited and portions of the build material layer on which no fusing agent is deposited of more than 1:7.

Feature set 4: A 3D printer with any preceding feature set 1 to 3, wherein the build material has a degree of crystallization below 25%

Feature set 5: A 3D printer with any preceding feature set 1 to 4, wherein the normalized integral of the standard Differential Scanning calorimetry (DSC) curve for the build material is below 35 J/g.

Feature set 6: A 3D printer with any preceding feature set 1 to 5, wherein the build material is a Thermoplastic Polyurethane (TPU).

Feature set 7: A 3D printer with any preceding feature set 1 to 6, wherein the left limit temperature of the build material fusing curve is about 105° C.

Feature set 8: A 3D printer with any preceding feature set 1 to 7, wherein the energy source is to emit energy at a narrow band of wavelengths.

Feature set 9: A 3D printer with any preceding feature set 1 to 8, wherein the energy source is to emit energy at the narrow band of wavelengths that includes wavelengths ranging from 445 to 455 nm.

Feature set 10: A 3D printer with any preceding feature set 1 to 9, further comprising a container with the energy absorbing fusing agent that absorbs over 75% of the energy received from the energy source.

Feature set 11: A 3D printer with any preceding feature set 1 to 10, wherein the energy source is a static energy source above the area in which the build material layer is to be generated.

Feature set 12: A 3D printer with any preceding feature set 1 to 11, wherein the energy source is part of a moveable carriage, wherein the carriage is to scan above and throughout the length of the area in which the build material layer is to be generated.

Feature set 13: A 3D printer with any preceding feature set 1 to 12, wherein the carriage comprises a plurality of rows of energy sources, each row spanning substantially the width of a build platform.

Feature set 14: A method of three-dimensional printing, the method comprising:
receiving a print job data of a 3D object to be generated from a build material with a right limit temperature of the build material crystallization curve higher than a left limit temperature of the build material fusing curve;
generating, by a build material distributor, a layer of build material;
selectively depositing, by an agent distributor, an energy absorbent fusing agent to the layer of build material based on the print job data; and
emitting, by an energy source, energy at a set of wavelengths comprised in the range of 430 to 1200 nm to the layer of build material to cause build material on which the fusing agent was deposited to melt, coalesce and then solidify upon cooling.

Feature set 15: A device comprising:
a reservoir with a build material having a right limit temperature of the build material crystallization curve higher than a left limit temperature of the build material fusing curve;
a build material distributor to generate layers of the build material from the reservoir to a build volume;
an agent distributor to selectively deposit an energy absorbent fusing agent to a layer of build material;
an energy source to emit energy at a set of wavelengths comprised in the range of 430 to 1200 nm; and
a controller to:
   receive print job data of a 3D object to be generated;
   control the build material distributor to generate a layer of build material;
   control the agent distributor to selectively deposit the fusing agent based on the print job data; and
   control the energy source to emit energy to the layer of build material to cause build material on which the fusing agent was deposited to melt, coalesce and then solidify upon cooling.

What is claimed is:

1. A method of three-dimensional (3D) printing, the method comprising:
receiving a print job data for a 3D object to be generated from a build material with a right limit temperature of a build material crystallization curve of the build material higher than a left limit temperature of a build material fusing curve of the build material;
generating, by a build material distributor, a layer of the build material;
selectively depositing, by an agent distributor, an energy absorbent fusing agent to the layer of the build material based on the print job data; and
emitting, by an energy source, energy at a set of wavelengths comprised in a range of 430 nm to 1200 nm to the layer of the build material to cause the build material on which the energy absorbent fusing agent was deposited to melt, coalesce, and then solidify upon cooling.

2. The method of claim 1, wherein the energy source provides a spectral selectivity ratio of more than 1:7 between portions of the layer of build material in which the energy absorbent fusing agent has been deposited and portions of the layer of build material on which no energy absorbent fusing agent has been deposited.

3. The method of claim 1, wherein the build material has a degree of crystallization below 25%.

4. The method of claim 1, wherein a normalized integral of a standard Differential Scanning calorimetry (DSC) curve for the build material is below 35 J/g.

5. The method of claim 1, wherein the build material is a thermoplastic polyurethane (TPU).

6. The method of claim 1, wherein the energy source is configured to emit energy at a narrow band of wavelengths.

7. The method of claim 6, wherein the energy source is configured to emit the energy at the narrow band of wavelengths that includes wavelengths ranging from 445 nm to 455 nm.

8. The method of claim 1, wherein the energy absorbent fusing agent absorbs over 75% of the energy received from the energy source.

9. The method of claim 1, wherein the energy source is a static energy source above an area in which the layer of the build material is to be generated.

10. The method of claim 1, wherein the energy source is part of a moveable carriage, wherein the moveable carriage is configured to scan above and throughout a length of an area in which the layer of the build material is to be generated.

11. The method of claim 10, wherein the moveable carriage comprises a plurality or rows of energy sources, each row spanning substantially a width of a build platform.

12. A method of three-dimensional (3D) printing, the method comprising:
receiving a print job data for a 3D object to be generated from a build material with a right limit temperature of a build material crystallization curve of the build material higher than a left limit temperature of a build material fusing curve of the build material;
generating, by a build material distributor, a layer of the build material;
selectively depositing, by an agent distributor, an energy absorbent fusing agent to the layer of the build material based on the print job data; and
emitting, by an energy source, energy using a wavelength to fuse a first portion of the layer of the build material with the energy absorbent fusing agent at a first temperature equal to or greater than the right limit temperature of the build material crystallization curve of the build material while maintaining a second portion of the layer of the build material without the energy absorbent fusing agent at a second temperature that is less than the left limit temperature of the build material fusing curve of the build material.

13. The method of claim 12, wherein the energy source provides a spectral selectivity ratio of more than 1:7 between portions of the layer of build material in which the energy absorbent fusing agent has been deposited and portions of the layer of build material on which no energy absorbent fusing agent has been deposited.

14. The method of claim 12, wherein the build material has a degree of crystallization below 25%.

15. The method of claim 12, wherein a normalized integral of a standard Differential Scanning calorimetry (DSC) curve for the build material is below 35 J/g.

16. The method of claim 12, wherein the build material is a thermoplastic polyurethane (TPU).

17. The method of claim 12, wherein the energy source is configured to emit energy at a narrow band of wavelengths.

18. The method of claim 17, wherein the energy source is configured to emit the energy at the narrow band of wavelengths that includes wavelengths ranging from 445 nm to 455 nm.

19. The method of claim 12, wherein the energy absorbent fusing agent absorbs over 75% of the energy received from the energy source.

20. The method of claim 12, wherein the energy source is one of:
a static energy source above an area in which the layer of the build material is to be generated; or
the energy source is part of a moveable carriage, wherein the moveable carriage comprising a plurality of rows of energy sources, wherein the moveable carriage is configured to scan above and throughout a length of an area in which the layer of the build material is to be generated.
